(19) United States
(12) Patent Application Publication
(10) Pub. No.: US 2025/0008887 A1
(43) Pub. Date: Jan. 9, 2025

(54) DEBRIS LOOSENING COMPONENT FOR LAWN BLOWER

(71) Applicant: Erik Matthew Nelson, Vacaville, CA (US)

(72) Inventor: Erik Matthew Nelson, Vacaville, CA (US)

(21) Appl. No.: 18/347,215

(22) Filed: Jul. 5, 2023

(51) Int. Cl. A01G 20/47; F04D 29/70

(52) U.S. Cl. CPC A01G 20/47; F04D 29/701

(57) ABSTRACT

A lawn blower having an air tube has a dislodging component, such as a pin or metallic brush attached to the lower end of the air tube, close to the nozzle of the tube. The dislodging component is part of the lawn blower and is used to loosen or dislodge debris from cracks and crevices so that the debris (e.g., dirt, grass, weeds, litter, and the like) can be cleared away by force of air emitted from the tube. In one configuration, the dislodging component can be turned into a utility position or to a storage or stow-away position.

### FIELD OF THE INVENTION

The present disclosure generally relates to the field of lawn blower apparatus. More specifically, it relates to a modification to a lawn blower air tube to make it more effective in clearing debris from cracks, crevices, and similar spaces.

### BACKGROUND

Present lawn blowers come in various types, such as hand-held models or models that are worn like a backpack. Some are powered by gasoline engines, others by electric motors. The output shaft of the engine or motor drives an impeller which generates air flow. The air travels through an air tube and out a nozzle. The velocity or force of the air flow out of the nozzle of a conventional lawn blower is sufficient for blowing small volumes or quantities of dry leaves, grass clippings, and other yard and lawn debris. However, the velocity of air flow from a conventional lawn blower is generally insufficient to dislodge debris or growth, such as weeds or grass, from cracks, crevices, narrow openings in concrete (such as in sidewalks or driveways), and similar spaces often found in lawns, walkways, sidewalks, driveways, patios, decks, and the like.

Presently, there is a variety of air tube and nozzle attachments for lawn blowers that can modify the air flow exiting the nozzle. These attachments can change the force of the air flow, coverage and direction of air flow, and other factors. However, they all require additional apparatus that need to be coupled with the nozzle or air tube of the lawn blower. In many cases these attachments and couplers need to be purchased separately from the blower and some manual steps need to be taken to mechanically couple the various attachments to the nozzle or air tube. In short, these solutions often require extra expense and additional steps to essentially modify the lawn blower (i.e., securing a coupler or attachment mechanism to a nozzle and then securing the needed attachment).

It would be preferable to have a lawn blower that is originally equipped with components needed to loosen debris from cracks, crevices, etc. and remove this debris using the original nozzle of the lawn blower. That is, a blower with a dislodging component without having to attach anything to the air tube or nozzle.

### BRIEF DESCRIPTION OF THE FIGURES

FIG. 1 is a perspective view of a lawn blower with a dislodging component in accordance with one embodiment;

FIG. 2 is a front-view perspective of an air tube of a lawn blower with a dislodging component in accordance with one embodiment;

FIG. 3 is a view of the inside of an air tube showing a configuration of securing the dislodging component to the tube in accordance with one embodiment;

FIG. 4 is a perspective view of a lawn blower with a different embodiment of a dislodging component in use in accordance with one embodiment;

FIG. 5 is a perspective view of a lawn blower with a dislodging component in use in accordance with one embodiment;

FIG. 6 is a frontal view of a dislodging component in accordance with one embodiment;

FIG. 7 shows a different embodiment of a dislodging component in an extended position in accordance with one embodiment;

FIG. 8 shows a different perspective of the dislodging component in extended position; and

FIG. 9 shows the dislodging component in a storage or stow-away position in accordance with one embodiment.

### SUMMARY OF THE INVENTION

In one aspect of the present invention, a dislodging component, also referred to as a pin in one embodiment, is part of an air blower tube. A lawn blower apparatus or machine, diesel or electric, has an air tube for directing air flow from a nozzle, said air tube having an exterior surface. A dislodging component, also referred to as a pin, is attached to the exterior surface of the tube and is perpendicular to the exterior surface and is attached in proximity to the nozzle of the air tube, such that the dislodging component loosens or dislodges debris which can thereafter be removed by the force of air emitted from the nozzle.

In an another aspect, a lawn blower apparatus has an air tube for directing air flow from a nozzle, the air tube having an exterior surface. A dislodging component, such as a pin, attached to the exterior surface of the air tube has a first, shorter segment for loosening debris that is perpendicular to the surface and a second, longer segment that is parallel to the exterior surface of the air tube, the dislodging component is configurable to be in either a storage position or to a utility position wherein the utility position includes the second segment of the dislodging component extending past the nozzle of the air tube and the first segment of the dislodging component extending past the nozzle and pointed towards the ground where it is used to loosen debris. A user can turn the component from a stowed position to a utility position. The component is part of the air tube, attached via conventional means, such as a screw, nut, and washer, in a manner that allows it to be turned. It is not an attachment or accessory that the user attaches to the air tube: it is intended to be part of the lawn blower.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present invention is a lawn blower having an air tube that has a dislodging component extending outward from the outer surface of the tube. As described below, the dislodging component can be one of various types. In the described embodiment, the component is a narrow cylindrical rod or pin wherein the diameter of the rod or pin decreases as it extends from the base, i.e., the outer surface of the air tube. In another embodiment, the dislodging component has a uniform diameter. In yet another embodiment, the component is a metallic brush. The invention is best described with reference to the figures.

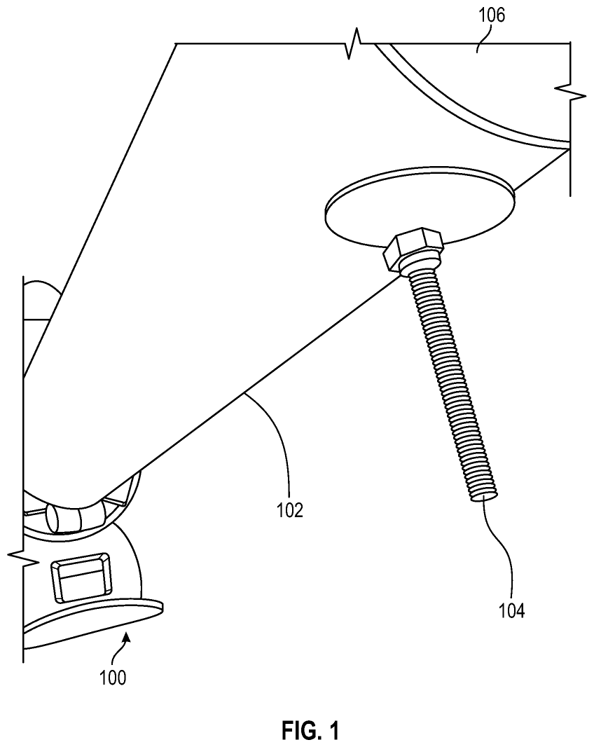

FIG. 1 is a perspective view of a lawn blower with a dislodging component in accordance with one embodiment. Blower 100 has an air tube 102 that expels air flow outward from a nozzle 106. One embodiment of a dislodging component 104 is shown. In this embodiment, component 104 is in the form of a screw or pin.

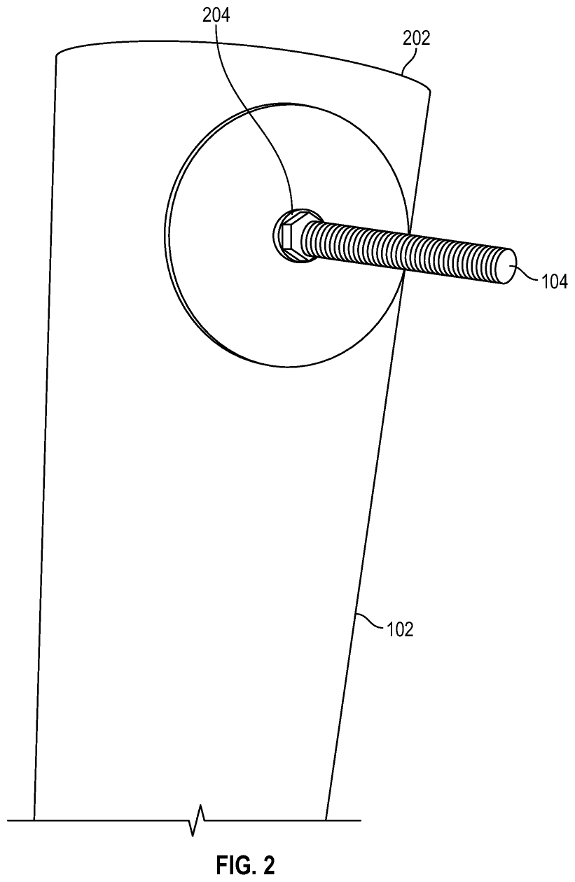

FIG. 2 is a front-view perspective of air tube 102 of a lawn blower 100 with dislodging component 104 in accordance with one embodiment. Air tube 102 has dislodging component 104 attached to tube 102 using a curved plate or washer 202 wherein the curvature is aligned with or equivalent to the curvature of air tube 102. Also shown is a lock nut 204 for securing plate 202 to air tube 102.

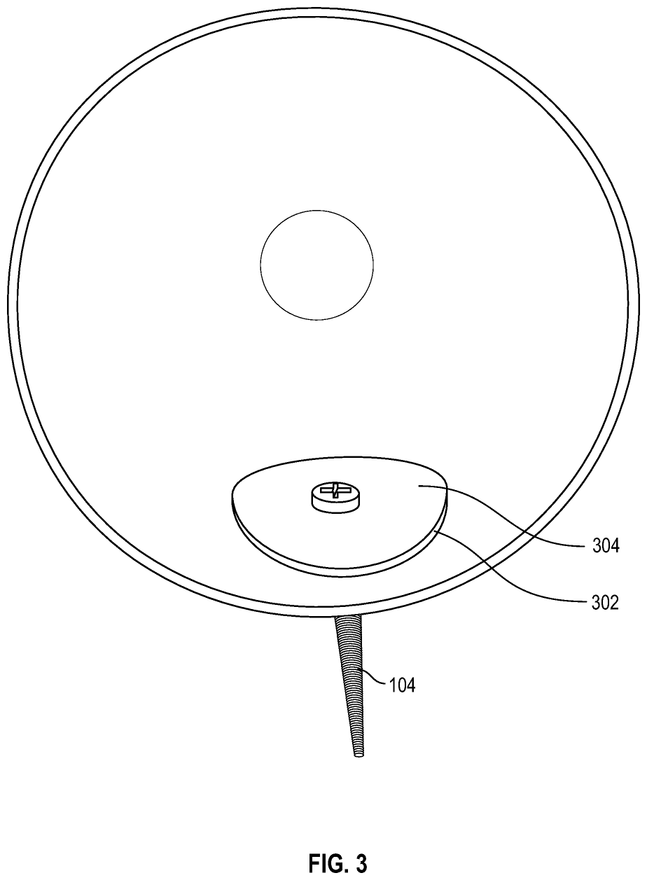

FIG. 3 is a view of the inside of air tube 102 showing a configuration of securing dislodging component 104 to tube 102 in accordance with one embodiment. Dislodging component 104 extends outward from tube 102. A plate or washer 302 similar to plate 202, has a curvature that is aligned with or equivalent to the inside surface curvature of tube 102. Plate or washer 302 is secured with lock nut 304.

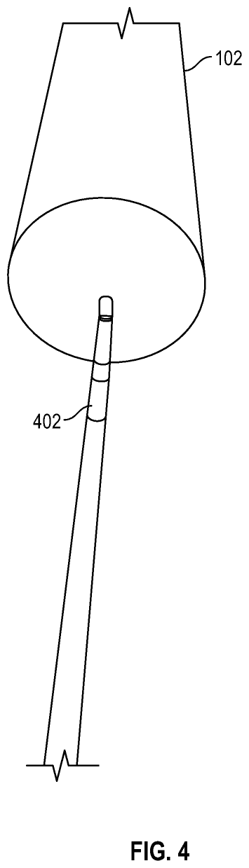

FIG. 4 is a perspective view of lawn blower 100 with a different embodiment of a dislodging component in use in accordance with one embodiment. A dislodging component 402 is similar to a metallic brush that is of a suitable width and length such that it allows component 402 to reach into or enter typical cracks and crevices found in lawns, driveways, sidewalks, and the like. As can be seen from the figure, dislodging component 402 is placed or positioned in a crevice and used by the lawn blower operator to move, loosen, or otherwise dislodge debris. This is the same case with dislodging component 104. Once this is done, air expelled from air tube 102 is able to blow the debris away and clear the crack, crevice, etc. Without loosening debris, weeds, dirt, grass, and the like by dislodging component 104 (integral to lawn blower 100), it is unlikely that the force of the air expelled from the nozzle would be able to remove it.

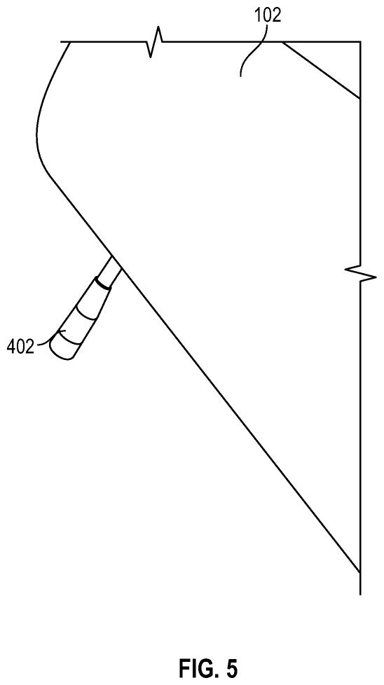

FIG. 5 is a perspective view of lawn blower 100 with dislodging component 402 in use in accordance with one embodiment. As with FIG. 4, the dislodging component can be component 104 or be a different shape or length that is suitable for being inserted into cracks, crevices, and the like. In FIG. 5 component 402 is shown loosening debris before air from tube 102 is used to clear the debris away.

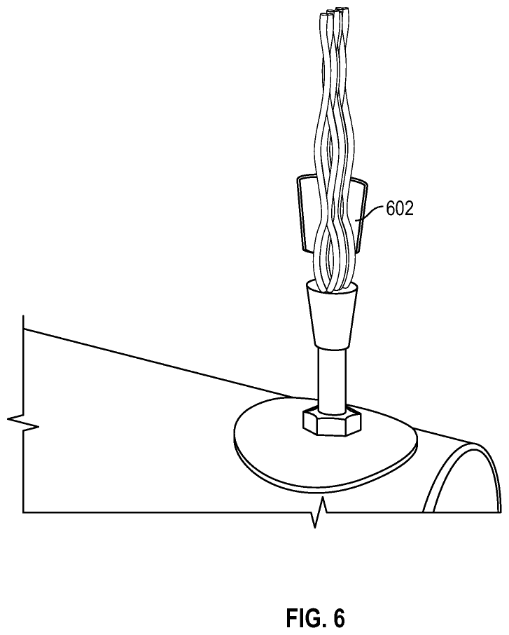

FIG. 6 is a frontal view of dislodging component 402 in accordance with one embodiment. As can be seen, means for securing component 402 is the same as the means used for component 104, namely, plate or washer 202 and lock nut 204, are used to secure component 402 to tube 102. In other embodiments, dislodging component can be a scraper, rake, or brush (as is component 402). As mentioned, dislodging component 402y, 104 can be of any suitable width and length of any structurally resilient material for clearing debris which can include dirt, weeds, pine straw, dried mud, wet leaves, and so on. This type of debris can be stuck or lodged in such spaces over time and is not easily lifted and separated from a surface or space. It is important to note that the dislodging component is structurally part of lawn blower 100; it need not be maintained separately as an attachment or blower accoutrement that needs to be secured to blower 100 by the operator.

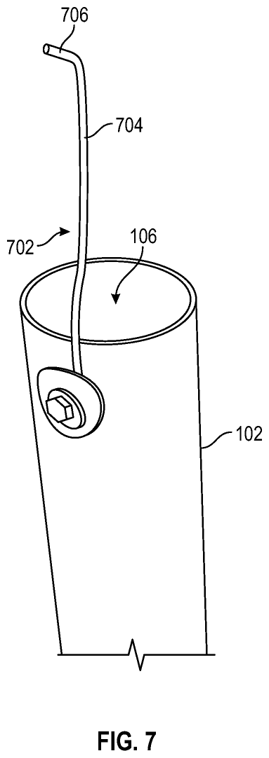

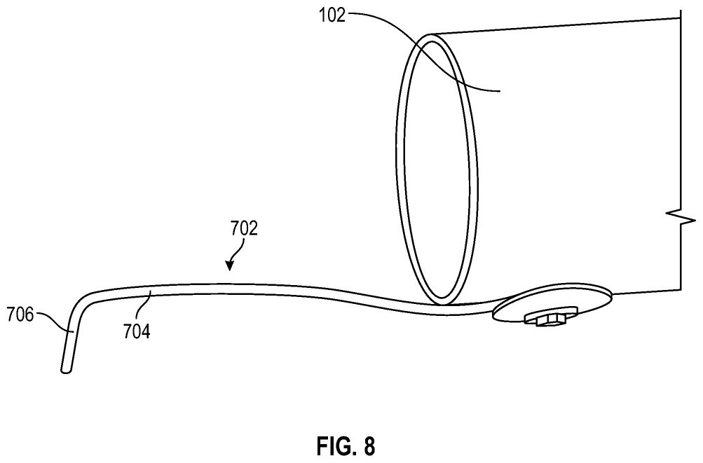

FIG. 7 shows air tube 102 and a different embodiment of pin 104 in accordance with one embodiment. In FIG. 7, a pin 702 extends beyond opening nozzle 106. In this configuration pin 702 has two segments, 704 and 706. This configuration enables segment 706 to loosen debris that is in front of opening nozzle 106. Segment 706 loosens debris which is then immediately blown by air coming from air tube 102. FIG. 8 shows same pin 702 from a side perspective. The exact shape and length of pin 702 (and segments 704 and 706) can vary. As can be seen in both figures, pin 702 is attached to air tube 102 by a conventional means, for example, a washer, bolt, and screw.

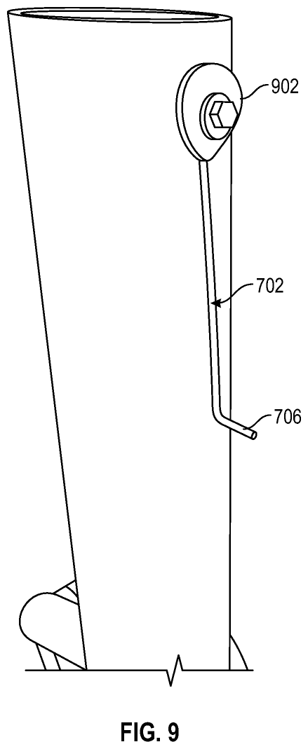

FIG. 9 shows pin 702 in a storage or stow-away position. Pin 702 is turned 180 degrees, in this example, so that it is now adjacent to the outside of air tube 102. By placing it in this position, pin 702 is in a position that facilitates storing the air tube. As can be seen, it is attached using a conventional means 902 that allows for pin 702 to be rotated and positioned against the physical tube. Pin 702 can then be turned 180 degrees to the position shown in FIGS. 7 and 8.

The preceding description contains significant detail regarding the novel aspects of the present invention. It should not be construed, however, as limiting the scope of the invention but rather as providing illustrations of the preferred embodiments of the invention.

What is claimed is:

1. A lawn blower apparatus comprising:
an air tube for directing air flow from a nozzle, said air tube having an exterior surface; and
a dislodging component attached to the exterior surface of said air tube wherein said dislodging component is perpendicular to said exterior surface and is attached in proximity to the nozzle of said air tube, such that said dislodging component loosens or dislodges debris which can thereafter be removed by air force out of said nozzle.

2. A lawn blower apparatus comprising:
an air tube for directing air flow from a nozzle, said air tube having an exterior surface; and
a dislodging component attached to the exterior surface of said air tube, the dislodging component having a first segment for loosening debris that is perpendicular to the surface and a second segment that is parallel to said exterior surface of the air tube, the dislodging component is configurable to be either in a storage position or in a utility position, wherein in said utility position, the second segment of the dislodging component extends past the nozzle of the air tube and the first segment of the dislodging component extends past the nozzle and points towards the ground where it is used to loosen debris.
